(19) United States
(12) Patent Application Publication
(10) Pub. No.: US 2026/0127872 A1
(43) Pub. Date: May 7, 2026

(54) FRAMEWORK FOR IDENTIFYING LANDMARKS IN AN IMAGE

(71) Applicant: Siemens Healthineers AG, Forchheim (DE)

(72) Inventors: Halid Yerebakan, Carmel, IN (US); Kritika Iyer, Conshohocken, PA (US); Gerardo Hermosillo Valadez, West Chester, PA (US)

(21) Appl. No.: 19/354,988

(22) Filed: Oct. 10, 2025

(30) Foreign Application Priority Data
Nov. 4, 2024 (DE) 102024132018.4

(51) Int. Cl. G06V 10/82; G06V 10/80

(52) U.S. Cl. CPC G06V 10/82; G06V 10/817; G06V 2201/07

(57) ABSTRACT

A framework for identifying landmarks in an image. The framework includes multiple agents, each agent being a functional module designed for seeking a predefined home-landmark and a number of further landmarks in a landmark-region around a position of the agent. Each agent defines or receives its start-position, estimates a home-displacement of its home-landmark, estimates vote-displacements of further landmarks in the landmark-region, and chooses an updated start-position. The updated start-position is determined from the estimated home-displacement and the vote-displacements for this home-landmark estimated by other agents.

### CROSS-REFERENCE TO RELATED APPLICATION

This application claims the benefit of priority from DE Application No. 10 2024 132 018.4, filed on Nov. 4, 2024, the contents of which are incorporated by reference.

### TECHNICAL FIELD

The present framework describes a system and a method for identifying landmarks in an image, a control-unit for a medical imaging system and a medical imaging system.

### BACKGROUND

Landmark localization is important for automatically processing images. There is a large variety of known landmark-identification procedures that partly provide automation tools for various workflow steps. One example for a tool automatically classifying pixels or voxels in an image for containing a given landmark is Adaboost. One example for a module that can be used for automatically finding landmarks is “ALPHA Technology and Voting”. This landmarking algorithm is composed of several cascaded Adaboost models which classify voxels in an image as containing a given landmark in a coarse-to-fine manner. After detecting several landmarks using Adaboost, a voting model based on the spatial correlation of landmark groups is used to remove outliers and interpolate missing landmarks. Optionally, the Adaboost and voting steps may be repeated after aligning the image to a canonical space, which improves robustness and speed of landmark detection. Training the Adaboost and voting models requires at least 50-100 annotations per landmark. Once the classifier is trained, landmarks can be found by scanning an entire image which takes about half a second per landmark.

Another example for an algorithm for automatically finding landmarks is “BodyGPS”. This algorithm is based on a self-supervised methodology for estimating normalized locations for landmarks using a regression network. This method generalizes many types of landmark locations without explicit supervised training for it. However, since no supervision is used, the estimates are not precise and may vary around 10 mm at 90% around the correct position. However, the runtime is fast with a single search agent around 50 ms.

Another example for an algorithm for automatically finding landmarks is “MedLSAM”. It is based on a method that may perform organ localization based on given templates. It uses similar regression methodologies by creating ground truth via relative displacements in the images. On the other hand, it does not consider relationships between target structures. Thus, the individual landmarks do not benefit from other found locations.

Noothout at. al. showed in their work “Deep learning-based regression and classification for automatic landmark localization in medical images” (IEEE transactions on medical imaging, 39(12), 4011-4022; 2020, which is herein incorporated by reference) that recent research has reported multiple landmark location estimation algorithms using global to local strategy with convolutional neural networks. The global network estimates all landmark locations at once using combination of classifier and regressor. Then, landmark specific model refines the proposed location. They report fast processing times with good localization precision. However, it still uses all patches within the image for localization estimation which is not necessary. Processing times reduced in GPU hardware that is a limitation in production environment.

Ghesu et. al. show in their paper “Multi-scale deep reinforcement learning for real-time 3D-landmark detection in CT scans” (IEEE transactions on pattern analysis and machine intelligence, 41(1), 176-189; 2017, which is herein incorporated by reference) that there are single agent supervised landmark search algorithms. In their setting, the agent updates its state with limited number of actions to find desired location. Reinforcement algorithm is used to train policy of the agent.

These methods are not able to identify landmarks in a robust and accurate, but yet also fast manner.

### SUMMARY

A framework for identifying landmarks in an image is described herein. The framework includes multiple agents, each agent being a functional module designed for seeking a predefined home-landmark and a number of further landmarks in a landmark-region around a position of the agent. Each agent defines or receives its start-position, estimates a home-displacement of its home-landmark, estimates vote-displacements of further landmarks in the landmark-region, and chooses an updated start-position. The updated start-position is determined from the estimated home-displacement and the vote-displacements for this home-landmark estimated by other agents.

### BRIEF DESCRIPTION OF THE DRAWINGS

FIG. 1 shows an exemplary system and predictions of an agent;

FIG. 2 shows the work of an exemplary system;

FIG. 3 shows multi agent estimates to update positions of individual agents; and

FIG. 4 shows the process performed with independently working agents.

The various embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practiced without these specific details.

### DETAILED DESCRIPTION

It is the object of the present framework to improve the known systems and methods and provide a system and a method for identifying landmarks in an image, a control-unit for a medical imaging system and a medical imaging system, for overcoming the above-described problems. Especially, it is an object of the present framework to provide a multi agent landmark search.

In the following, a way to search for landmarks and using voting strategy simultaneously in every step of the search is described, improving both speed and robustness. It should be noted that the finding of landmarks is not the core of the present framework. The present framework provides exact results in short time by using a special architecture.

A system according to the present framework serves to identify landmarks in an image. This system comprising multiple agents (e.g., working in parallel) each agent being a functional module designed for seeking a predefined home-landmark and a number of further landmarks in a landmark-region around a position of the agent. Each agent of the system may be designed for:
a) defining or receiving its start-position,
b) estimating a home-displacement of its home-landmark,
c) estimating vote-displacements of further landmarks in the landmark-region,
d) choosing an updated start-position, determined from the estimated home-displacement and the vote-displacements for this home-landmark estimated by other agents,
e) repeating steps b) to d) with the updated start-position as start-position until a termination condition is reached.

It should be noted that the system may comprise other models, even other models that may be designated as “agents”, that are used for other purposes. The expression “each agent” should, thus, be understood as “every agent that is meant to do the task of finding landmarks”in the manner of the present framework.

Thus, the landmark identification system comprises multiple agents (e.g., working in parallel to enhance speed) to identify multiple landmarks in an image. Each agent is a functional module designed to seek a predefined home-landmark and a number of additional predefined landmarks within a specific landmark-region, which may be the whole image or an individual-region for each agent. The home-landmark of an agent is the landmark the agent should seek or to which the agent is assigned.

The agents may be imagined as entities moving over the surface of the image in the direction of their home-landmark. However, this is only a possibility to enhance understanding. In reality, each agent is a calculation model (e.g. based on Adaboost) that approaches a variable position (start-position/updated start-position) to the home-position of its home-landmark. Thus, the identification of the (unknown) home-position of the home-landmark is done by the approaching process. The last updated start-position may be interpreted as home-position of the home-landmark.

Regarding the expressions “position” and “displacement”, it may be difficult to separate these expressions on first sight. With an “position” a coordinate in an image is meant. Since an image may be two-dimensional or three-dimensional (e.g. an MRI-image or CT-image), the position may be also two-or three-dimensional. A displacement may be a position or a vector or a direction and a distance seen from the start-position. The term “displacement” should imply that the start-position is still not the home-position of the home-landmark and there is a displacement to this home-position. There is a also displacement from the start-position to the estimated positions of the other landmarks. As example for a “vote-displacement” there may be estimated a “vote-position”, a “vote-vector” or a “vote-direction/distance”.

The start-position is the position where the agent is “placed” on the image. As said above, there is no real positioning but each agent chooses or calculates its start-position. There is an initial start-position (e.g., individual initial start-position for each agent) where each agent starts and an “updated start-position” that is the new start-position for the next iteration step. In the pictorial example that agents move over the image, the start-position and updated start-position may be interpreted as agent-position. And also later, the expression “agent-position” is used as the current start-position of another agent. An agent may receive its initial start-position as predetermined position or choose it randomly. All agents may start from the same point (e.g. the center of the image) or in the center of the landmark-region assigned to the respective agent. For good understanding it may be imagined that there is a landmark-region for each agent, wherein the landmark regions are distributed over the whole image and overlap with each other and each agent chooses its initial start-position in its own landmark-region. However, since the landmarks are initially unknown, the landmark-region may be the whole image for at least some of the agents.

Each agent is designed to estimate the displacement of its assigned home-landmark from the current start-position. This displacement is designated as “home-displacement” to indicate that it refers to the home-landmark of the agent. This home-displacement may be based on an estimated home-position or home-vector of the home-landmark or also on an estimation of the direction to the home-landmark and an estimated distance to the home-landmark.

Additionally, each agent Ai is designed to estimate the displacement of other landmarks within its landmark-region, i.e. the home-landmarks of other agents from the current start-position of the agent Ai. This displacement is designated as “vote-displacement” to indicate that it refers to the home-landmark of other agents and is used later for “voting” the new start-positions. This vote-displacement may be based on an estimated position of the other landmark, or also on an estimation of the direction to the other landmark and an estimated distance to the other landmark or also a vector from the start-position of agent Ai to the other landmark.

To find a displacement (as well home-displacement as vote-displacement), there are several possibilities that are known in the art. The present framework enables a robust and fast identification of an accurate position of landmarks.

For a good understanding, the displacements may be imagined as arrows from each start-position to the estimated positions of the landmarks, where the arrow of the home-displacement may have another color as the arrows of the vote-displacements. In reality, the displacements may be datasets of vectors.

For estimating displacements, the agents may comprise machine learning algorithms trained to localize landmarks. Such algorithms analyze features and patterns within the image to estimate the most likely location of a landmark.

Now, for a home-landmark for agent Ai, there may probably be several possible positions. One is the position that may be derived from the start-position of agent Ai and the home-displacement and the other positions are the positions that may be derived from the start-positions of other agents and the vote-displacements of these other agent for this home-landmark of agent Ai. It should be noted that any displacement may be the position or a vector to this position.

Each agent tries to approach the (real) “home-position” of its home-landmark (not known) by choosing an updated start-position nearer to its home-landmark. This updated start-position is a new start-position based on the estimated home-displacement and the vote-displacements predicted by other agents. The updated start-position may be determined with a regression mechanism that combines the estimations of the agent and the other agents for the home-landmark. The determination may be performed by a central instance of the system or by each agent, wherein each agent may update its start-position individually, since this is much faster than calculating all updated start-positions centrally. This procedure is then repeated with the updated start-positions, i.e. from these new start-position new displacements are estimated and new updated start-positions are derived from them. The agents interact with each other by sharing their estimated vote-displacements, allowing them to update their start-positions and to improve their landmark identification accuracy. This process is repeated until a termination condition is reached.

In some implementations, the termination condition is reached when all agents converge on a consistent set of landmarks (e.g. when the distance between old start-positions and updated start-positions is lower than a predefined minimal threshold), or when a predetermined number of iterations has been completed.

A method according to the present framework for identifying landmarks in an image with a system comprises the following steps:
providing image-data,
forwarding datasets of the image-data to the agents, wherein each agent at least receives its landmark-region of the image-data as dataset,
processing (e.g., parallel-processing) of the datasets by the agents wherein each agent:
a) defines or receives its start-position,
b) estimates a home-displacement of its home-landmark,
c) estimates vote-displacements of further landmarks in the landmark-region,
d) chooses an updated start-position, determined from the estimated home-displacement and the vote-displacements for this home-landmark estimated by other agents,
e) repeats steps b) to d) with the updated start-position as start-position until a termination condition is reached.

Most of the exemplary method has already been explained above by describing the function of the agents. However, it will be shortly summarized in the following.

First, image-data is provided. This is data of a digital image, especially defining the color or greyscale of pixels of voxels. The present framework is very advantageous for processing medical images since for these images, landmarks are often needed for automated procedures e.g. identifying organs or image-registration. Thus, for good understanding, one may imagine that the image-data is a medical image showing organs or bones and landmarks should be inserted to special points in the image.

Then, the image data is distributed to the agents. Each agent may receive the whole image-data or a part of the image-data. Since for an agent the landmark-region is essential, it is only necessary to forward datasets of the image-data that include the landmark-region to this agent. However, each agent may also choose its landmark-region from the image-data, itself so that the whole image-data may be sent to any agent. It should be noted that the landmark-region may be a predefined subvolume of the image-data or a predefined sparse sampling descriptor for a neuronal network of an agent. That part of data could be data around a current start-position. Initially, it may be far from the landmark-position.

Now, the datasets received by the agents are processed. This may be performed by parallel-processing, since this is much faster than sequential processing. The architecture of the system is such that each agent may be processed parallel to the other agents.

In the course of the process, each agent defines or receives its (initial) start-position (predefined and/or randomly chosen) and estimates a home-displacement of its home-landmark as well as vote-displacements of further landmarks in the landmark-region of this agent. This procedure has already been described above. The finding of landmarks is state of the art. Now the agents exchange their information such that each agent receives vote-displacements for its home-landmark from the other agents. From the home-displacement and the received vote-displacements, an updated start-position is derived (e.g. by regression). Thus, each agent derives its start-position for the next iteration (i.e. the updated start-position).

Now, in the next iteration step, each agent again defines or receives its start-position being the updated start-position and the process for determining a new updated start-position from estimated displacements is started again and again until a termination condition is reached.

The method may advantageously be included into a BodyGPS regression algorithm. However, other regression neural networks are equally applicable for the multi-agent implementation of the method. Also, subvolumes may be used instead of sparse sampling descriptors. The advantage of BodyGPS is the fast computation for the operation. Beyond BodyGPS, proposed solutions use multiple agents and multiple regressions at the same time. This may provide the benefit of voting implicitly which contributes to robustness.

In praxis, a single agent may comprise a network estimating relative distances of all landmarks (at least in the landmark-region) to the agent's position. This network has then been trained with a randomly sampled points and supervised landmark positions. Each agent in this setting may then seek its specified landmark while voting for the other landmark locations. A multi regression head may be used. Then, this agent's position may be updated by a weighted average of other agent's votes and responsible agent's estimation. Once the agent gets closer, it may have a more precise estimate while the other agents'vote provides robustness in the picture.

An agent may be regarded as an abstraction of a position within the image and an assigned home-landmark. The algorithm computes the relative displacements to go to all possible landmarks in the agent's position. The regression may be performed by computing the descriptor or the subvolume in the agent's location and applying a trained neural network on it. One implementation of the neural network comprises a residual network that takes an input descriptor and outputs positions of landmarks in a world coordinate system. The advantage of a residual network is that it allows a better flow of input information for a better model as a result. An initial descriptor may be projected into a lower dimension with a linear projection layer to reduce amount of computation in later layers. After the initial projection, several layers may be applied with a residual connection. Each layer contains linear weights, normalization and nonlinear swish activation functions. The last layer projects hidden state into displacements vectors for each landmark in 3-dimensional coordinate system.

However, since multiple agents are used, there may be multiple landmarks within the consideration in each image. Also, each agent may estimate vote-displacements to home-landmarks of other agents. In the multi agent setting, each agent is assigned to a specific home-landmark and uses displacement vectors to get closer to its home-landmark. Displacement estimations may be performed in parallel, thereby increasing the speed of computation.

A control-unit according to the present framework serves for a medical imaging system. It comprises a system according to the present framework and/or is designed to perform a method according to the present framework.

A medical imaging system according to the present framework comprises the control unit according to the present framework.

Some units or modules of the present framework mentioned above can be completely or partially realized as software modules running on a processor or processing unit of a computing system. A realization largely in the form of software modules can have the advantage that applications already installed on an existing computing system can be updated, with relatively little effort, to install and run these units of the present application. The object of the present framework is also achieved by a computer program product with a computer program that is directly loadable into the memory device of a computing system, and which comprises program units to perform the steps of the methods, at least those steps that may be executed by a computer, when the program is executed by the computing system. In addition to the computer program, such a computer program product can also comprise further parts such as documentation and/or additional components, also hardware components such as a hardware key (e.g., dongle) to facilitate access to the software.

A non-transitory computer readable medium or memory device, such as a memory stick, a hard-disk or other transportable or permanently-installed carrier can serve to transport and/or to store the executable parts of the computer program product so that these can be read from a processor unit of a computing system. A processor unit can comprise one or more microprocessors or their equivalents.

Particularly advantageous embodiments and features of the present framework are given by the dependent claims, as revealed in the following description. Features of different claim categories may be combined as appropriate to give further embodiments not described herein.

In some implementations, each agent comprises a machine learning network, trained for estimating the home-displacement of its home-landmark and the vote-displacements of further landmarks in the landmark-region. With such machine learning network, landmarks may be searched and their position in an image may be identified.

However, it should be noted that the position may not be accurate, such that the vote-displacements of other agents are very valuable for a robust identification of landmarks. In some implementations, the machine learning network comprises a Resnet architecture.

Alternatively, or additionally, the machine learning network was trained to compute relative displacements to go to all landmarks in the landmark-region and/or was trained with randomly sampled points and supervised landmark positions.

It should be noted that it is not essentially necessary to search for the other landmarks in the image in order to estimate the vote-displacements. In the case, relative positions of landmarks to each other are known, the vote displacements may also be derived from an estimated home-position of the home-landmark and the known relative positions. By using relative displacements, one accurate home-landmark estimation may guide another one without explicit neural network estimation.

An exemplary system is designed such that each agent receives the vote-displacement of its home-landmark estimated by other agents. Thus, not a central instance determines the updated start-position, but each agent for itself. Here, each agent is designed to determine the updated start-position based on its estimation of the home-displacement and the received vote-displacements received from other agents.

In some implementations, the system is also designed such that each agent receives the current agent-positions of at least the other agents that provide vote-displacements (i.e. the current start-positions of these other agents). In this case, each agent may be designed to determine the updated start-position based on a weighted determination where vote-displacements of nearer agents have a greater weight than vote-displacements of farther agents. With this weighting, agents that are nearer and, therefore have a better “look” on the home-landmark of another agent may be favored by this agent. Here it should be noted that this embodiment is advantageous in the case distance has a negative effect on estimating vote-displacements e.g. in the case where relative displacements are estimated. In some implementations, the system, especially each agent, is also designed to determine the updated start-position based on a weighted determination where vote-displacements having a distance greater than a predefined threshold from the current start-position or home-displacement have a smaller weight (e.g. “0”) than nearer vote-displacements. With this weighting, vote-displacements that are far away (and therefore not trustable) may be ignored.

An exemplary system comprises multiple independent calculation units (e.g. processors and memory units) and wherein different agents are processed with different calculation units. Each agent is processed with an individual calculation unit so that all agents are processed in parallel. This seriously speeds up the procedure.

According to an exemplary system, a number of the agents, the system, or each agent, comprises multiple regression heads designed to determine an updated start-position based on based on a home-displacement and vote-displacements. These heads may be used for voting for different landmarks.

An exemplary system, or each agent, is designed to choose updated start-positions by determining an average position or a median position from an estimated home-displacement and vote-displacements estimated by other agents. The updated start-position of an agent is the determined average position or a position between the current start-position of this agent and the determined average position.

In general, each agent determines (first estimation, then regression) a home-position of its home-landmark and that this determined home-position is the updated start-position. Thus, in the imagination that the agents move over the image, each agent determines a position of its home-landmark, moves to that position and looks in the next iteration whether this position is correct or not.

According to an exemplary system, each agent comprises a residual network that is designed to receive an input descriptor of a current start-position of an agent in the image, and wherein the residual network is trained to output vote-displacements of landmarks in a world coordinate system. The agent is designed to project the input descriptor into lower dimension with a linear projection layer, in order to reduce amount of computation in later layers. Alternatively, or additionally, the agent is designed to apply several layers of the residual network with residual connection, after the initial projection. Here, an exemplary neural network has different layers and the first layer of the neural network is the initial projection.

In some implementations, the system, especially each agent, determines the current agent-positions of at least the other agents (i.e. their current start-positions) that provide vote-displacements and each agent determines the updated start-position based on a weighted determination where vote-displacements of nearer agents have a greater weight than vote-displacements of farther agents. Alternatively, or additionally, vote-displacements pointing to farther positions from the current start-position of the agent have a smaller weight (e.g. “0” when exceeding a predefined threshold) than vote-displacements pointing to nearer positions from the current start-position of the agent.

According to an exemplary method, the updated start-position is determined based on a linear regression of the estimated home-displacement and the positions of this home-landmark estimated by other agents, especially a weighted linear regression.

According to an exemplary method, the utilization of displacement vectors is formulated as weighted average of vote estimation and assigned agent's displacement. In some implementations, the weighted average is based on the formula: d1=λ·d1+(1−λ)median{di}Ni=1. In this equation, agent's displacement estimation d1 is updated by a median estimation of other agents (the displacement estimations di of N other agents) using the scaling factor of λ and wherein λ is updated during the process giving more weight to an agent's own estimation once this agent is getting closer to its assigned landmark.

The use of AI-based methods (AI: “artificial intelligence”) may be applied in some implementations. Artificial intelligence is based on the principle of machine-based learning and is usually carried out with an adaptive algorithm that has been trained accordingly. The expression “machine learning” is often used for machine-based learning, which also includes the principle of “deep learning”.

The methods may also include elements of “cloud computing”. In the technical field of “cloud computing”, an information technology (IT) infrastructure is provided over a data-network, storage space or processing power and/or application software. The communication between the user and the “cloud” is achieved by means of data interfaces and/or data transmission protocols. In the context of “cloud computing”, provision of data via a data channel (for example a data-network) to a “cloud” may take place. This “cloud” includes a (remote) computing system, e.g. a computer cluster that typically does not include the user's local machine. The cloud service may provide computing power as well as application software.

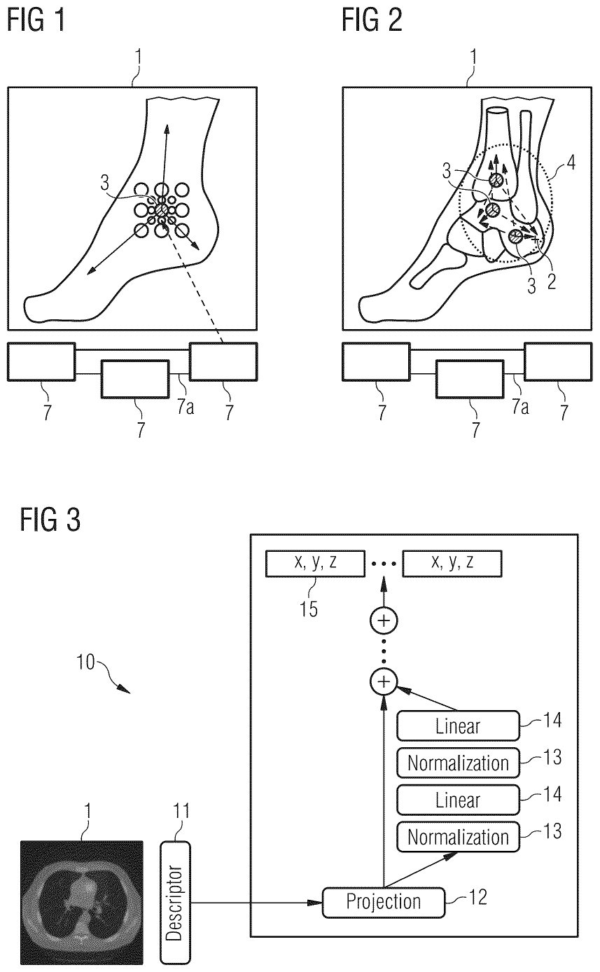

FIG. 1 shows a system 7a for identifying landmarks 2 in an image 1 and predictions of an agent. The system 7a comprises multiple agents 7 and the plurality of interacting agents 7 working in parallel. Each agent 7 is a functional module designed for seeking a predefined home-landmark 2 and a number of further landmarks 2 in a landmark-region 4 around a position of the agent 7. Shown here is the case, where an agent 7 seeks landmarks (indicated by the arrows) from a start-position 3 in an X-ray image 1 of a foot. The position of the landmarks is not known yet.

FIG. 2 shows the work of the system 7a of FIG. 1. Each agent 7 is designed for defining or receiving its start-position 3, estimating a home-displacement 5 (solid arrows) of its home-landmark 2, estimating vote-displacements 6 (dashed arrows) of further landmarks 2 in the landmark-region 4, choosing an updated start-position 3a, determined from the estimated home-displacement 5 and the vote-displacements 6 for this home-landmark 2 estimated by other agents 7 and repeating these steps with the updated start-position 3a as start-position 3 in the form of several iterations. It should be noted that the landmarks 2 are not known.

FIG. 3 shows multi-agent estimates to update positions of individual agents 7. Shown is a network 10 that may be part of every agent. The network 10 comprises a descriptor 11, a projection-layer 12, normalization-layers 13, linear-layers 14 and an output-layer 15. An image 1 is inputted into the initial descriptor 11 and is projected into a lower dimension with the linear projection layer 12 to reduce amount of computation in later layers. After the initial projection, several layers, the normalization-layers 13, linear-layers 14, are applied with a residual connection. Each layer contains linear weights, normalization and nonlinear swish activation functions. The last layer projects hidden state into displacements vectors for each landmark in 3-dimensional coordinate system (estimating a displacement to reach landmark from the current position).

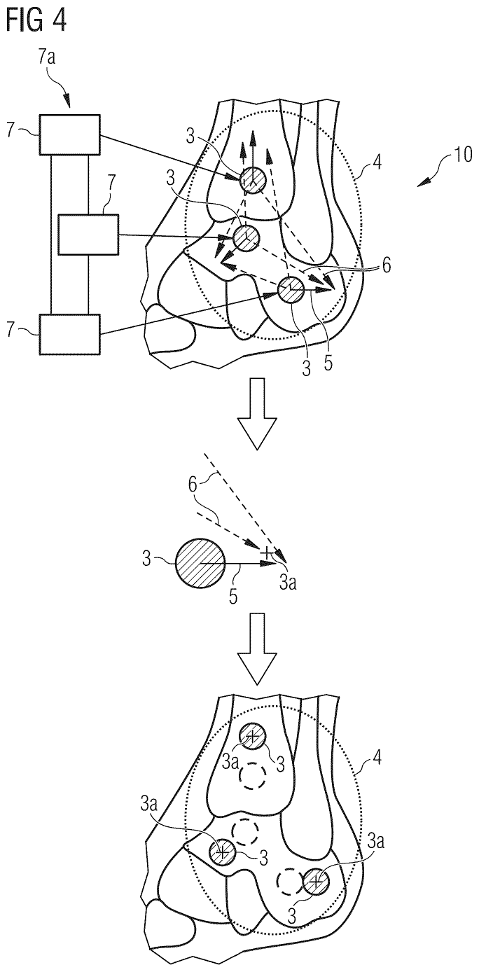

FIG. 4 shows the process performed with independently working agents 7. First, image-data in form of an x-ray image 1 of a foot is provided and the image data is distributed to the agents 7 of the system 7a. Each agent 7 here receives the whole image-data and chooses its own landmark-region 4, that is here the same. In praxis, each agent 7 probably has its individual landmark-region. The datasets received by the agents 7 are processed (indicated by arrows from the agents into the image 1). In some implementations, the processing is performed by parallel-processing, since this is much faster than sequential processing. In the course of the process, each agent defines its initial start-position 3 (shown here as hatched circles) and estimates a home-displacement 5 of its home-landmark as well as vote-displacements 6 of further landmarks in the landmark-region 4. This is shown in the upper part.

Now, in the middle part, any agent 7 receives vote-displacements 6 of the other agents 7 and from the home-displacement 5 and the received vote-displacements 6, an updated start-position 3a is derived by regression.

In the bottom part, each agent derives its new start-position 3 for the next iteration from the updated start-position 3a (hatched circles). For comparison, the dashed circles show the initial start-positions.

Now, in the next iteration step (move again to the upper part), each agent again defines or receives its start-position 3 being the updated start-position 3a and the process for determining a new updated start-position 3a from estimated displacements is started again and again until a termination condition is reached.

Although the present framework has been disclosed in the form of preferred embodiments and variations thereon, it will be understood that numerous additional modifications and variations may be made thereto without departing from the scope of the invention. For the sake of clarity, it is to be understood that the use of “a” or “an” throughout this application does not exclude a plurality, and “comprising” does not exclude other steps or elements. The expression “a number of” means “at least one”. The mention of a “unit”or a “device”does not preclude the use of more than one unit or device.

Independent of the grammatical term usage, individuals with male, female or other gender identities are included within the term.

### List of Reference Signs

1 image
2 landmark
3 start-position
3a start-position (updated)
4 landmark-region
5 home-displacement
6 vote-displacement
7 agent
7a system
10 network
11 descriptor
12 projection-layer
13 normalization-layer
14 linear-layer
15 output-layer

1. A system for identifying landmarks in an image, comprising:
one or more processing units; and
a non-transitory memory device communicatively coupled to the one or more processing units, the non-transitory memory device stores computer readable program code, the one or more processing units being operative with the computer readable program code to perform steps including:
a) defining or receiving, by an agent, a start-position,
b) estimating, by the agent, a home-displacement for a home-landmark,
c) estimating, by the agent, vote-displacements for further landmarks in a landmark-region,
d) choosing, by the agent, an updated start-position, determined from the home-displacement and vote-displacements for the home-landmark estimated by other agents, and
e) repeating steps b) to d) with the updated start-position as start-position until a termination condition is reached.

2. The system according to claim 1 wherein the agent comprises a machine learning network trained for estimating the home-displacement of the home-landmark and the vote-displacements for the further landmarks in the landmark-region.

3. The system according to claim 2 wherein the machine learning network comprises a Resnet architecture.

4. The system according to claim 2 wherein the machine learning network is trained to compute relative displacements to go to all landmarks in the landmark-region.

5. The system according to claim 1, wherein the agent receives the vote-displacements of the home-landmark estimated by the other agents, wherein the agent determines the updated start-position based on the home-displacement and the vote-displacements received from other agents.

6. The system according to claim 1, wherein the agent receives current agent-positions of at least the other agents that provide the vote-displacements and the agent determines the updated start-position based on a weighted determination, wherein vote-displacements of nearer agents have a greater weight than vote-displacements of farther agents.

7. The system according to claim 1, wherein the agent determines the updated start-position based on a weighted determination, wherein farther vote-displacements having a distance greater than a predefined threshold from a current start-position or a home-displacement have a smaller weight than nearer vote-displacements.

8. The system according to claim 1, wherein the system comprises multiple independent calculation units and wherein different agents are processed with different calculation units.

9. The system according to claim 1, wherein the agent comprises multiple regression heads designed to determine the updated start-position based on the home-displacement and the vote-displacements.

10. The system according to claim 1, wherein the one or more processing units are operative with the computer readable program code to choose the updated start-position from a determined average position or a median position from an estimated home-displacement and the vote-displacements estimated by the other agents.

11. The system according to claim 1, wherein the one or more processing units are operative with the computer readable program code to choose the updated start-position from a determined average position or a position between a current start-position of the agent and the determined average position.

12. The system according to claim 1, wherein the agent comprises a residual network that receives an input descriptor of a current start-position of the agent in the image, and wherein the residual network is trained to output vote-displacements of landmarks in a world coordinate system.

13. The system according to claim 12, wherein the agent projects the input descriptor into lower dimension with a linear projection layer.

14. The system according to claim 12, wherein the agent applies several layers of the residual network with residual connection after an initial projection.

15. A method for identifying landmarks in an image, comprising:
providing image-data;
forwarding datasets of the image-data to agents, wherein each agent at least receives a landmark-region of the image-data as dataset; and
processing, by the agents, the datasets, including
a) defining or receiving, by at least one of the agents, a start-position,
b) estimating, by the at least one of the agents, a home-displacement for a home-landmark,
c) estimating, by the at least one of the agents, vote-displacements for further landmarks in the landmark-region,
d) choosing, by the at least one of the agents, an updated start-position determined from the home-displacement and vote-displacements for the home-landmark estimated by other agents, and
e) repeating steps b) to d) with the updated start-position as start-position until a termination condition is reached.

16. The method according to claim 15, further comprising:
determining current agent-positions of at least the other agents that provide vote-displacements; and
determining the updated start-position based on a weighted determination.

17. The method according to claim 15, wherein the updated start-position is determined based on a linear regression of the home-displacement and position of the home-landmark estimated by the other agents.

18. The method according to claim 15, wherein the at least one of the agents utilizes displacement vectors to get closer to the home-landmark, wherein the displacement vectors are determined based on a weighted average of vote estimation and assigned agent's displacement.

19. The method according to claim 15 wherein the processing, by the agents, the datasets comprises parallel-processing.

20. One or more non-transitory computer-readable media embodying instructions executable by machine to perform operations for identifying landmarks in an image, comprising:
a) defining or receiving, by an agent, a start-position,
b) estimating, by the agent, a home-displacement for a home-landmark,
c) estimating, by the agent, vote-displacements for further landmarks in a landmark-region,
d) choosing, by the agent, an updated start-position, determined from the home-displacement and vote-displacements for the home-landmark estimated by other agents, and
e) repeating steps b) to d) with the updated start-position as start-position until a termination condition is reached.
